(19) United States
(12) Patent Application Publication
(10) Pub. No.: US 2006/0136575 A1
(43) Pub. Date: Jun. 22, 2006

(54) Integrated security suite architecture and system software/hardware

(76) Inventors: Ray Payne, Sierra Madre, CA (US); Shaiwal Priyadarshi, Pasadena, CA (US); Jerry Herbert Shaw, Barstow, CA (US); James Oakley Lowder, Helotes, TX (US)

Correspondence Address: George R. Schultz;Schultz & Associates, P.C., One Lincoln Centre, 5400 LBJ Freeway, Suite 1200, Dallas, TX, 75240, US

(21) Appl. No.: 11/268,880

(22) Filed: Nov. 7, 2005

Related U.S. Application Data
(63) Continuation-in-part of application No. 10/843,180, filed on May 11, 2004.
(60) Provisional application No. 60/625,255, filed on Nov. 5, 2004.
(60) Provisional application No. 60/625,240, filed on Nov. 5, 2004.
(60) Provisional application No. 60/625,239, filed on Nov. 5, 2004.
(60) Provisional application No. 60/625,283, filed on Nov. 5, 2004.

(51) Int. Cl. G06F 15/16

(52) U.S. Cl. 709/219

(57) ABSTRACT

Disclosed is a multi-user, multi-tasking, state-of-the-art computer-based package for providing real-time distributed processing and control of a variety of system functions and capabilities. The invention provides an integrated security suite architecture and system software/hardware combination for security operations. The suite employs a Digital Media System (DMS) to provide live and recorded closed circuit TV (CCTV) capability and audio surveillance. The suite blends a host of modular software/hardware plug-ins that provide seamless integration of intrusion detection systems (IDS), access control systems (ACS), and management reporting systems (MRS) for efficient and effective security management plans for new or existing operations. Also provided in the invention is a controller card for regulating entry to at least one security door. The controller card has a microprocessor, flash memory, a network communications port, ports for accessing card readers and ports for controlling doors.

### CROSS REFERENCE TO RELATED APPLICATIONS

This application is a continuation-in-part of application Ser. No. 10/843,180 filed May 11, 2004. This application further claims priority from U.S. provisional patent application 60/625,255 filed on Nov. 5, 2004, which is hereby incorporated by reference. This application further claims priority from U.S. provisional patent application 60/625,240 filed on Nov. 5, 2004, which is hereby incorporated by reference. This application further claims priority from U.S. provisional patent application 60/625,239 filed on Nov. 5, 2004, which is hereby incorporated by reference. This application further claims priority from U.S. provisional patent application 60/625,283 filed on Nov. 5, 2004, which is hereby incorporated by reference.

### INTRODUCTION

This invention relates to an integrated architecture and system of software and hardware for accomplishing security operations employing a digital media system to provide live and recorded closed circuit TV (CCTV) capability and audio surveillance and more particularly to a system of combining modular software/hardware plug-ins for integration of intrusion detection systems, access control systems, and management reporting systems for efficient and effective security management.

### BACKGROUND OF THE INVENTION

Within the security industry there exist two main types of customers: 1) those that have a need for only one security function; and, 2) those that insist upon a complete range of integrated security components. For those that have a need for only one security function (e.g., monitoring a building) current security management systems typically consist of individual autonomous systems and/or components for intrusion detection, alarm management, access control, and audio and video surveillance and recording. Any necessary integration of such individual autonomous systems or components is typically left to the installer, integrator or user. As a result of this conventional design system methodology, prior art security management systems have limited integration capability. Limited integration produces an inefficient use of available resources having multiple data entry points and duplicate databases within the system operation. In addition, limited integration creates inefficient use of personnel by duplicating data entry tasks, requiring manual data exchange between systems and implementing duplicate training requirements. Limited integration also causes the unnecessary expense of additional hardware and software accompanied by multiple stand-alone units having similar but different functionality.

One result of similar but different stand alone units is unreliable security due to personnel confusion, inconsistent training, and lack of efficient procedures. Furthermore, compatibility is often lost due to continuous upgrades on various portions of systems controlled by separate manufacturers. Troubleshooting problems also arise which encompasses hardware issues between different system component suppliers. Traditionally, integration and interfacing of different systems has been limited by maintenance capabilities of information technology personnel. Software and hardware integration is also a limitation.

The current trend for those who require having a complete range of integrated security components (e.g., large federal and state government agencies as well as large corporate entities) is to have security systems dispersed at local and remote sites that can be centrally monitored, allowing system administrators at a central control center to oversee activity at remote facilities.

There are well-known problems with analog transmission used by prior art security management systems. Examples are high signal bandwidth which requires a dedicated and costly cable for each video channel and true analog long distance transmission which is high susceptibility to interference causing video quality degradation along the transmission path as well as on the record media. Prior art analog systems also suffer from reduced compatibility with modern software methodologies.

Modern computer systems are utilized increasingly in security management systems. These new systems require analog signals to be converted to digital format. A digital format can transmit video across long distances at a low cost. Digital systems provide a host of other benefits. For example, digital systems combine video compression with Ethernet networks thereby allowing many video signals to be transmitted across a various communication media, such as a single twisted-pair or CAT-5 cable. Digital systems offer noise tolerant transmission and recording thereby providing cleaner images. Digital sensors provide digital data from the sensor which allows better integration of audio & video components and easier linking of remote and local locations.

A digital format overcomes some of the limitations of analog signals, but can introduce other problems. For example, “codec artifacts” (blocky or fuzzy images caused during the video compression stage) can render the digitally acquired images useless. Another example is increased latency and partial image display due to delays and errors in the transmission medium. Yet another example is incompatibility between different digital data transmission systems.

What is needed therefore is an efficient security management system where multiple system types operate simultaneously and effectively. Such a security management system may be one single system with integrated management of intrusion detection to provide alarm and event monitoring, reporting, response and access control. Such a security management system may provide controlled and managed access to property and physical assets, with identification badges and associated database management. Such a security management system may also provide management reporting to provide report level information from a database, event history, and general system operation reporting. Such a security management system may also provide audio and video media with integrated and managed access to many channels of audio, video and other media.

### SUMMARY OF THE INVENTION

The present invention includes systems and methods for a modular security system that is capable of multifunctional operation. Modular design allows adaptation to large or small scale security requirements and upgrade capability by addition of “plug-in” modules.

The network topology provided allows for the addition of security of components comprising access control, alarm management, and audio/video storage and control functions to an existing network or the construction of a specialized security network. The invention further provides Wide Area Network (WAN) connectivity based on TCP/IP communications allowing geographically separate sites to be accessed, operated, and controlled as if they were a single system.

Different embodiments of the modular security system are capable of integrating dispersed systems back to one or more central control centers for local and remote monitoring. The modular security system can be enlarged virtually without limit. The modular security system allows the deployment of equipment to meet the customers' requirements and allows scalability to be instituted for a few devices at many sites, many devices at a few sites, or many devices at many sites.

Additional embodiments of the present invention allow for workstations to be connected to servers on a network without the need to change user interfaces. Once a workstation is connected to a server, the workstation will receive activity from that server just as if the system were connected to a single server. Additionally, the present invention can connect small sites to a single server via networked field controllers, or can connect to servers from across the country or around the globe.

Other embodiments of the modular security system provide for a digital media system (DMS) that controls most aspects of the technologies required to provide a digital alternative to analog CCTV. Features of the DMS comprise high-quality audio & video digitization, compression and transmission through the use of high-fidelity, full-resolution and high frame-rate compression techniques. A major portion of the hardware included in the present invention enables direct-connect Ethernet communications to system computers, field controller panels, fixed or dome cameras, and digital media recording system (DMRS) servers. Direct Ethernet connection results in a simple and cost-effective method for equipment installation.

The DMS provides LAN and WAN access via Ethernet connectivity based on TCP/IP communications for unrestrained scalability of numbers of deployed units that are useful in localized and global applications. The DMS further provides plug-and-play devices that allow for simple, convenient, and rapid deployment of digital media networks. In the DMS, whenever devices are attached to a network, device management software can immediately begin communicating with each device, allowing for immediate inclusion of that device into the modular security system. If devices are replaced, the previous device's configuration can be stored and imported into a new device, thereby reducing the amount of time any particular environment is unprotected.

In another embodiment, all monitors and recorders are connected to a central network and have access to all video channels being transmitted on that network. Just like analog systems, and unlike most digital systems, there is no degradation when more than one viewer connects to a video channel because the video is already at full resolution and full frame rate. For similar reasons, which distinguish it from other digital solutions, the DMS rules do not degrade the video quality on the core network when a video channel is “exported” across an external network, such as the Internet or an ISDN line. By utilizing the same core/external data-rate buffering technology, the DMS also allows immediate & real-time review of recorded video at playback stations, even when the playback stations are separated from the recorder by an external network. This aspect of the DMS removes the need to first transfer or buffer the video clip at the playback station, an aspect which uses both the operator's time and the network's bandwidth inefficiently and unnecessarily. When an interesting recording has been found, that recording, or a portion of it, can be exported to the operator's workstation, where it can then be viewed in the high-fidelity at which it was recorded.

Consequently, a video-switching network can be expanded by simply attaching new cameras or monitors or recorders, updating the management software with the details of the new devices and enabling the new system configuration. There is no re-wiring or component to upgrade. One of the key areas enabled by moving to networked devices is the ability to control and monitor multiple devices at any time. With this level of simplicity, video switching and installation costs are reduced while expanding the level of operational capability.

### BRIEF DESCRIPTION OF THE DRAWINGS

The accompanying drawings, which are incorporated in and constitute a part of the specification, illustrate, but do not serve to limit, the various embodiments of the present invention and, together with the description serve to explain the principles of the invention.

FIG. 1 is a diagram depicting the software application framework of the present invention;

FIG. 2 is a diagram depicting the network topology and component deployment in the integrated security suite of the present invention;

FIG. 3A is a diagram depicting an integrated digital controller network with security management system components and panel modules of the present invention;

FIG. 3B is a diagram depicting an overview of the security management system of the present invention;

FIG. 3C is a schematic diagram of the inputs and outputs of the dual door control board;

FIG. 3D is a diagram depicting a method for granting access to a door in accordance with the functions of the dual door controller;

FIG. 3E is a diagram depicting a method of resistance measurement;

FIG. 3F is a diagram depicting a front view of an exemplary embodiment of an arming control unit;

FIG. 4 is a diagram of a preferred embodiment of a network system configuration of the present invention;

FIG. 5 is a diagram of a preferred embodiment of a stand-alone system configuration of the present invention;

FIG. 6 is a diagram depicting a hybrid analog and digital network system including integrated third party domes, cameras and a matrix switcher combined with a Digital Media Recording System (DMRS); and,

FIG. 7 is a diagram depicting the Digital Media System (DMS) architecture with associated IP devices and Core and External networks as defined by the present invention.

### DETAILED DESCRIPTION OF THE INVENTION

The numerous innovative teachings of the present invention will be described with particular reference to one or more of the preferred embodiments (by way of example, and not of limitation). In the descriptions that follow, like parts are marked throughout the specification and drawings with the same numerals. The drawing figures are not necessarily drawn to scale and certain figures may be shown in exaggerated or generalized form in the interest of clarity and conciseness.

Framework and Architecture for the Integrated Security Suite

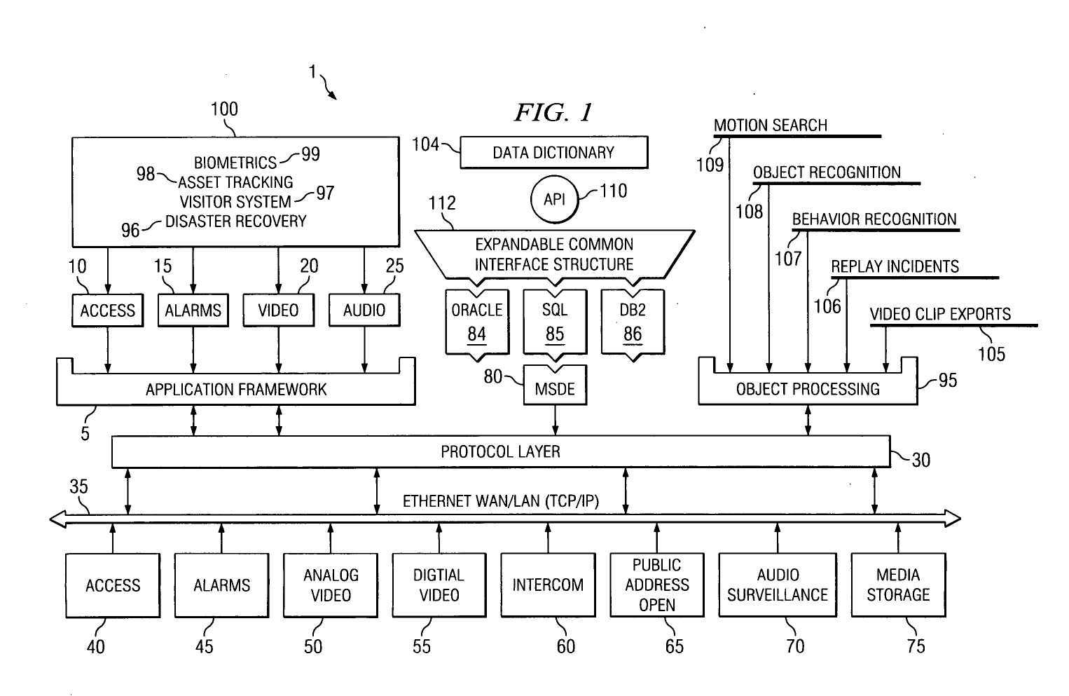

As shown in FIG. 1, the security system 1 and application framework 5 software of the present invention provides operational features including authenticated access and control of system information and options to utilize various database tables (e.g., Oracle 84, SQL database 85, and DB2 86) as well as system control, monitoring, response, and logging functions. The architecture and application framework 5 are expandable using modular software plug-ins.

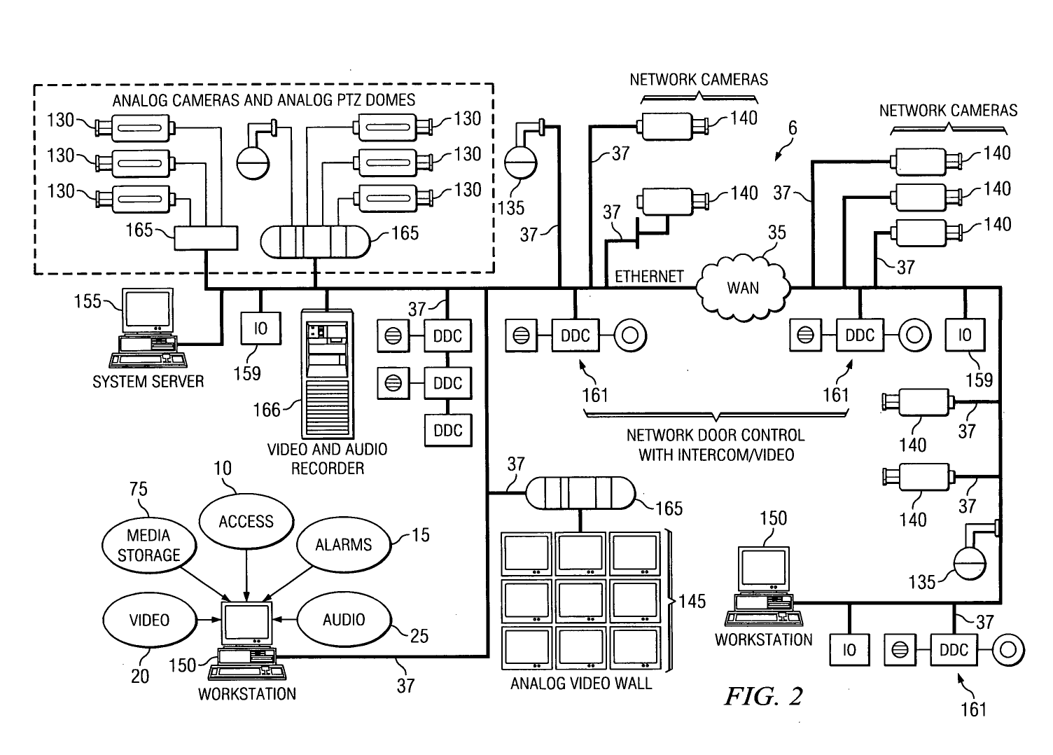

In further reference to FIG. 1 and FIG. 2, application framework 5 is built on a base functional program designed as a two-tier system employing integration workstations 150 and system server 155 which communicates over standard Ethernet 35 using TCP/IP protocols to interconnect all components and devices. Ethernet technology employed within the system include, but are not limited to, IEEE 802.3 and 802.3u (wired UTP CAT-5), 802.11b (wireless 2.4 GHz) and HomePlug (HP). The use of standard Ethernet 35 allows for instantaneous building-wide, metropolitan, and global communications. The following comprises a non-exclusive list of system capabilities per server and is intended to provide only a representation of capabilities and is not intended to be limiting in scope:
Over 49,000 alarm input points
Over 49,000 relay output points
Unlimited intrusion detection accounts
Up to 99 arming control codes per account (representing people authorized to open or close an area)
Unlimited dispatch files
Unlimited command files
On average more than 325,000 transaction log records per gigabyte of storage.
Central system capable of sustaining over 120 transactions per second
Unlimited time controlled events
Unlimited database reports with over 100 existing report templates
Integrated report writing utilities
Interactive graphical map displays
Unlimited graphical maps
Global linkage capability (any alarm point can be linked to any output on the server)
Message vectoring by time and by workstation failure or shutdown
Virtual server monitoring, any or all server monitoring at any workstation network-wide
Disaster recovery configuration
Application manager service that ensures that critical programs never terminate
Integration provides for alarm and access control messages to share the same action devices

In application framework 5 there are four general functional areas of plug-ins.

These plug-ins include, but are not limited to, access control 10, alarm management module 15, digital video 20, digital audio 25, and audio/video and control function digital media recording system 75 through the use of a digital media recording system (DMRS) 75. These plug-in modules are fully functional and, when installed in groups or individually, application framework 5 facilitates the installation.

The capabilities of the plug-ins are enhanced by technology 100 which operates mutually exclusively of the plug-ins. Each technology 100 is explained as it relates specifically to the access control 10 plug-in. For example, a biometrics 99 portion may be added to access control 10 including a fingerprint detector. Asset tracking 98 may enable a tracking capability for monitoring status, location, physical aspect, or movement of assets (e.g. PC, humans, vehicles, etc.). A visitor system 97 can restrict movement of visitors in a building or complex of buildings. This effectively limits visitors to certain areas and triggers alarms if a visitor enters an unauthorized area. Disaster recovery 96 can safe-guard system failures by the utilization of redundant servers, redundant networks, or any other viable system backup. Disaster recovery 96 provides for intelligent card readers having the ability to operate even if the primary system goes down by maintaining local copies of card-holder information. The general objective of disaster recovery 96 is to keep the on-site security system running even when the main system is experiencing a failure.

Security system 1 and framework 5 provide a rational blend of data networking technologies and applications via the individual software plug-ins that provide a seamless integration of intrusion detection, access control, and CCTV. Framework architecture 5 permits upgrade of older existing analog systems simply by plugging-in a desired module as needed. Network architecture 6 provides a PCB motherboard to which can be connected to an access control board, an alarm management board, an audio/video board, and/or media storage control board. The benefit of such architecture is that each of these modular component plug-ins connects to a network backbone.

FIG. 1 further shows a plurality of network appliance devices that can be connected to the network backbone and operationally act as plug-ins. Such network appliance device plug-ins comprise access appliances 40 (e.g., card readers reading magnetic strip cards, and pin pads etc.), alarm management appliances 45 (e.g., passive IR detectors detecting heat and motion to set off trigger conditions in the form of electrical circuit closure due to voltage changes), alarms (which send an alarm packet onto the network 38 etc.), analog video appliances 50 (e.g., analog cameras, monitors, etc.), digital video appliances 55 (e.g., compression/“codec” cards, IP cameras etc.), intercom appliances 60 (e.g. when associated with access appliances 40 the appliance may have an intercom system at a door to enable communications by a guard and person at the door and microphones associated with cameras, etc.), public address appliances 65 (e.g., microphones to broadcast announcements over speakers in a building in a digital format using standard equipment and standard Ethernet 35 and standard IP, etc.), audio surveillance appliances 70 (e.g., microphones randomly situated in a building etc.), and DMRS appliances 75 (e.g., devices which provide the ability to store digital video/audio into a network accessed database file).

Each of the plug-in appliances includes cooperating components of software required for operation and network communication. One component is installed in a background system such as a server or network appliance. The other component is installed onto a workstation providing the user access the network appliance.

Security system 1 is built upon a database packages such as SQL database 85, Oracle 84, or DB2 86. Other database management packages will function equally as well. The present invention performs report generation utilities via a structured query language (SQL) based report generation package such as MDI Report Writer or Seagate Crystal Reports. The system is designed to allow a choice of database management packages. Therefore, the database operates as a plug-in. Database dictionary 104, working in conjunction with a selected database, defines the basic organization of the chosen database. A data dictionary contains a list of all files in the database, the number of records in each file, and the names and types of each field. An application programming interface 110 provides a common set of functions linking the data dictionary to expandable interface structure 112. The expandable interface structure 112 is a common set of software modules that allows information to be transferred to and from database packages. The database packages in turn interface with a database management package such as MSDE 80, as known in the art. MSDE 80 in turn communicates with protocol layer 30.

The databases provide for entry of each individual record file. Each entry is tagged with the media access control (MAC) address of the source camera, the IP address of the source camera, the date and time the record started, the date and time the record started and ended, and all alarms associated with that specific record. All such data will represent one entry in the database. The file containing the digital media is itself not actually recorded in the database. The database simply points to a format file which is stored elsewhere in the filing system of a data recorder. The database entry maintains whether the file is located on a hard disk or if it has been copied to a tape archive, or deleted from the system altogether. If the file was deleted, it can be determined if it was done automatically or performed by an operator. Tracking records are also kept indicating if the file was ever exported to a CD or DVD, and if so the identity of the operator exporting the file and notes made at the time of exportation. Tracking records provide accountability, and better security monitoring practices.

A protocol layer 30 is depicted in FIG. 1. The protocol layer disassembles network data from a packet when received from of Ethernet 35 from a specific appliance or device and converts the data into a database entry. For example, protocol layer 30 allows database changes (e.g., when a work station is configured by Ethernet 35 commands sent over Ethernet 35. The present invention utilizes a generic protocol layer 30 to enable configuration of third party devices to the Ethernet 35.

Object processing layer 95 is provided in security system 1. Object processing layer 95 comprises several individual layers each providing data processing that can operate on workstation 150, system server 155 or a network appliance. For example, the video clip export portion 105 and replay incidents portion 106 operate allow export of digital video data or data generated from database queries. Motion search portion 109 operates with live and/or pre-recorded video and allows access to designated regions of specific interest in a field of view. For example, a camera can be configured to provide all instances where motion occurs in the specific field of view or region of interest. In operation, the system will remain idle until something enters that designated field of view. In the case of a pre-recorded file, the system can rapidly scan that file and place bookmarks in each section that had motion in the specific field of view region of interest. Object recognition portion 108 provides the ability to scan segments of video frame to recognize or distinguish objects, features, patterns, colors. Behavior recognition portion 107 provides the ability to determine movement of an object in a specified direction or non-movement of an object for a given amount of time. In either case, an alarm or other network action can be triggered in response.

In FIG. 2, a diagram depicting network topology and an example of various system components are provided in a reference to a preferred embodiment of the invention. Integrated workstations 150 are provided which function a client side terminals within the system. Integrated workstations 150 have plug-in software modules that can be selectively loaded that relate to digital video 20, digital audio 25, alarm management module 15, access control 10, and DMRS 75. Integrated workstations 150 allow the user to configure network appliances so as to enable a management interface that shows all installed appliances/devices and to configure each appliance.

Once configured by the integrated workstations 150, the network appliances send notification messages in the form of alarms to a system server 155. The database can be accessed to locate listed events from system server 155. In addition, system server 155 can be configured to automatically forward various alarms that may require operator intervention (e.g., intruder detect alarms) directly to workstation 150. Integrated workstation 150 can configure the system and provide an interface to configure the system. Once configured the system can request important alarm events be pushed from the system server 155 to the integrated workstation 150. In addition, the topology provides for the use of codec card units 165, system server 155, and other system components to enable the user to direct connect to Ethernet 35 utilizing CAT 5 connections 37. Of course other standard Ethernet connection standards will work as well.

An embodiment of the system of the present invention provides integration of existing analog cameras 130 and analog PTZ domes 131 by use of codec card units 165. By use of the codec card units 165, existing analog monitors 145, analog cameras 130 and other analog equipment can be used by a digital network. Also provided are network-ready components that do not require the use of codec card units 165. These components may comprise dual door controllers 160, digital cameras 140 and digital domes 135, digital video/audio recorder 166, and integrated workstations 150.

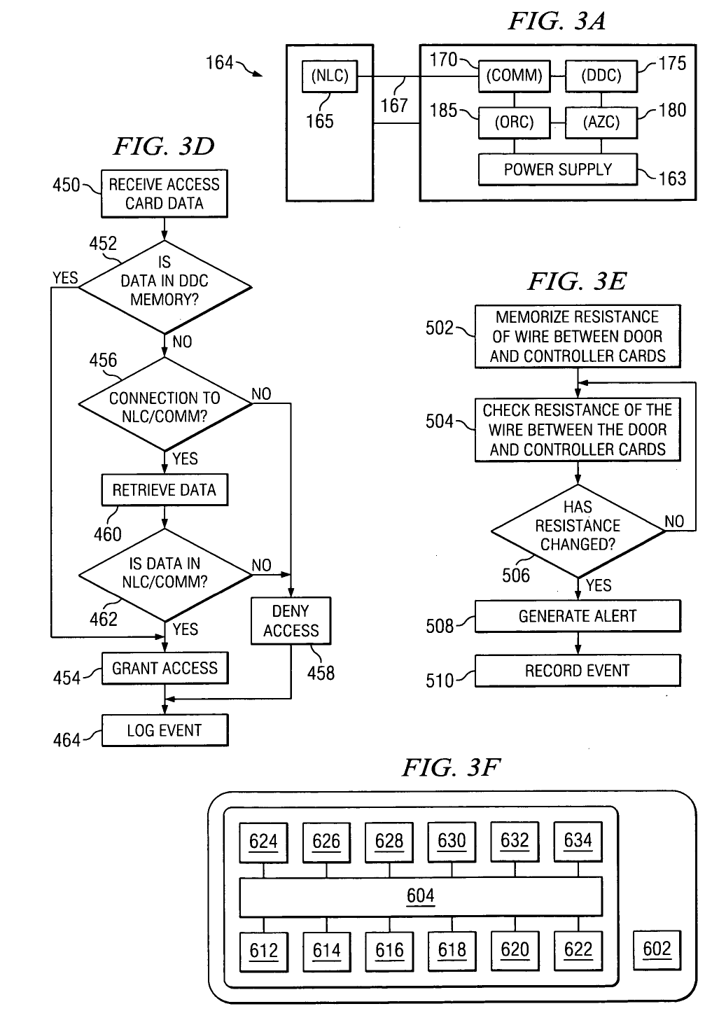

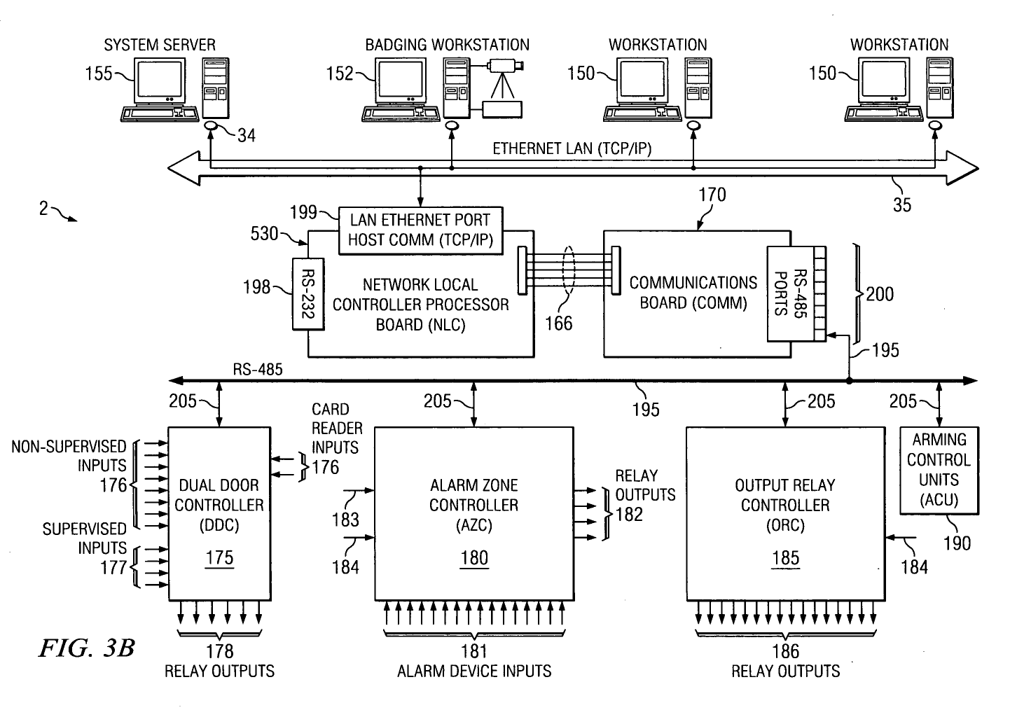

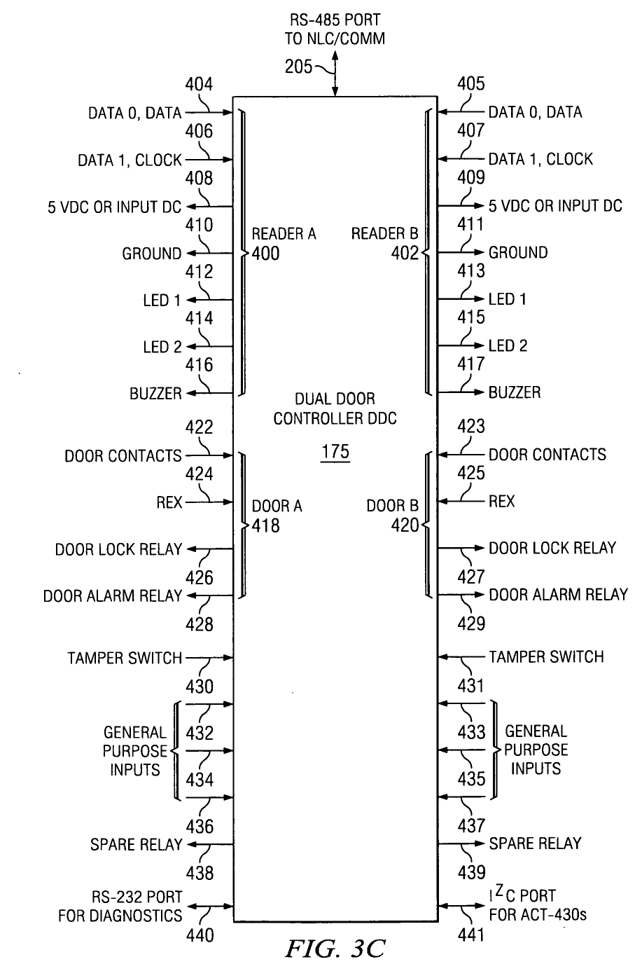

Referring to FIG. 3B a diagram depicting an overview of the security management system 2 configuration of the present invention. The system provides centralized security alarm management incorporating security intrusion detection monitoring, annunciation and reporting, alarm management and arming control An event and response logging/archive is provided in conjunction with card access/entry control, personnel administration, digital video, audio monitoring and recording and integrated video imaging/badging. The system incorporates an easy-to-use graphical user interface (GUI) with simple point and click database editing and system monitoring controls.

The security management system 2 is comprised of at least one system server 155. The server in one embodiment, a Pentium Class PC utilizing a Windows 2000 operating system and a database program. At least one workstation 150 is included in the security management system 2. In one preferred embodiment the workstation is a Pentium Class PC utilizing a Windows 2000 operating system. The preferred embodiment can accommodate a maximum of 255 workstations. At least one badging workstation 152 is included. The badging workstation includes a video source 500, a video digitalizer 505 and a badge printer 510. The components of the badging workstation cooperate to create text and photographic badges capable of supporting a magnetic data stored or other portable data storage device (not shown). The workstation sand servers are connected via Ethernet 35. The SQL server provides complete transactional data integrity, automated backups, automatic maintenance, and provides an open architecture for interfacing to any other ODBC capable databases.

Security management system 2 provides for a multi-user, multi-tasking computer-based system that provides real-time, distributed processing and control of numerous system functions and capabilities. The alarm management features and operational capabilities are performed by the base functional program software and can support very large, scalable security systems to span large geographical areas and use the central station alarm management design. Security management system 2 further uses “plug-in” applets, as mentioned earlier, that are small modules dynamically loaded into the framework to provide comprehensive current features, as well as future new or special capabilities. The applets provide a level of expandability and customization capabilities required for today's high security industry.

The Integrated Digital Controller (IDC)

Reference is made to FIGS. 3A and 3B. IDC 164 is a fully distributed network security management system. Network Local Controller (NLC) 530 and Communication (COMM) board module 170 make up the IDC 164 management components that link between a system server 155 to other IDC 164 panels containing field hardware. At least one NLC 530 is connected (for example by a ribbon cable 166) to at least one COMM 170 and functionally connected with at least one or more field devices. The field devices comprise an alarm zone controller (AZC) 180 (which monitors supervised alarm inputs 181), dual door controller (DDC) 175 (which supports access control), and/or output relay controller (ORC) 185 (which controls relay outputs 186). Also utilized is at least one arming control unit (ACU) 190 (where arming control is performed). Each of these controllers 175, 180, 185 and 190 connects with the system processor using a RS-485 communication ports 200 available on communication board 170. In addition, a self-contained power supply unit 163 is supplied as part of the IDC 164 cabinet enclosure.

The IDC 164 can be physically housed in any number of enclosures to meet most installation requirements. Enclosures are provided with locks, tamper switches and mounting holes. Power supply 163 and batteries for module operation are supported in all enclosure types as well. IDC 164 systems are configurable using any combination and number of field devices up to 64 card readers, 32 DDC modules 175 and/or up to 512 I/O modules. A total of 48 device module addresses are supported in a single IDC 164 and up to 64 IDC systems are supported by server 155.

The Network Local Controller and Communications Board

In further reference to FIG. 3B, a preferred embodiment of NLC 530 comprises a micro-controller consisting of at least a 32-bit microprocessor having at least one fully integrated, onboard 10-Mb Ethernet, TCP/IP LAN communication port 199 for host communications as well as a plurality of RS-485 communication ports 200 located on the communication board 170 for security module communications and at least one RS-232 port 198 for diagnostics purposes. In addition, NLC 530 contains at least 4 MB FLASH ROM memory for downloaded software code and configuration parameters and a static RAM (e.g.: 16 MB, expandable to 64 MB) for database, data parameters, and transaction/event storage. NLC 530 can support local event storage of a plurality of access (e.g.: 10,000) and alarm transactions and a plurality of card records (e.g.: 64,000, expandable). The configuration may further contain multiple NLCs 165 each having multiple communication means such as a plurality of RS-485 communication ports 200 for local system communication and direct interface to the AZC 180, DDC 175, and/or ORC 185 modules, as well as other field devices including ACU 190.

NLC 530 serves as the local system controller processor board and can be configured in several ways. For example, a first NLC 530 can control a first AZC 180, a first DDC 175, and a first ORC 185. A second NLC 530 can control a second AZC 180, a second DDC 175, and a second ORC 185. Both the first and second NLCs are controlled by the server or workstation. NLC 530 effectively passes appropriate cardholder records to each dual door controller DDC 175. DDC 175 can make access control decisions for up to two readers (not shown) using a local cardholder database. Access requests are made to NLC 530 only when a card's data is not in DDC 175 database. If the data is among the records in NLC 530 database, NLC 530 makes the access control decision and passes it on to DDC 175. Access requests are made to the host computer when the card data is not present in NLC 530 cardholder database. Each NLC 530 is network linked via Ethernet LAN communication port 34 to system server 155 running IDC 164 via an on-board, direct connect (e.g.: 10-Mb) Ethernet LAN communication port 34.

In reference to FIGS. 3A and 3B, NLC 530 links supervised alarm point monitoring and reporting from the AZC 180 to server or workstation which connects to the base functional program for operator response and acknowledgement. AZC 180 interfaces to NLC 530 via a communication means such as a supervised RS-485 channel 195 and provides a plurality of fully supervised alarm inputs 181, along with a plurality of auxiliary relay outputs 182 per module.

Unique to the communications board (COMM) 170 is a resistance memory capability. The communication board 170 may receive from any of the connected device a resistance of the wire between a controller card and a door.

Turning to FIG. 3E, depicted is a flow chart describing the method of resistance detection of the communication board 170. In the method of FIG. 3C, the communication board 170 memorizes the resistance of the wire between the door and the controller cards at step 502. Resistance can be measured by methods or devices such as an ohmmeter or applying a voltage and measuring the resulting current. This resistance is then stored in flash or RAM memory aboard the communication board 170 or NLC 530. The communication board 170 then checks the resistance between the wire and the controller cards periodically at step 504 and compares the present resistance to the originally stored value of the resistance at step 506. If the resistance has not changed, the communication board 170 resumes the periodic checking of the resistance until a change in resistance is detected. If a change in resistance is detected, the communication board 170 can generate an alert to the security system and set off an alarm. The communication board 170 will also record in the RAM the time and date of the change in the resistance and whether or not the alarm has sounded.

For example, the communication board 170 memorizes the resistance of a wire between the door control and DDC 175 or between the door control and the AZC 180. If a wire between the door and DDC 175 is cut in an attempt to bypass the access card reader, the communication board 170 will realize the change in resistance and send out an alert. Also, if a wire between the door and AZC 180 was cut in an attempt to avoid the alarm, communication board 170 would recognize the change in wire resistance and send out an alert. As described the primary purpose in memorizing the resistance between the door control and a controller card is to detect when the wire has been cut in an attempt to bypass the security system.

Alarm Control Unit (ACU)

Arming control for the system can be performed by an ACU 190. ACU 190 includes a digital keypad and LCD display, key switches, and/or simple keypads. Each ACU 190 interfaces and communicates with communications board 170 and NLC 530 via a communication medium such as a 22 AWG, 2-wire twisted pair cable using standard 2-wire RS-485 channel 195. ACU 190 is provided to open/close (arm/disarm) an area of alarm zones for one or more designated field devices in the IDC 164 system. Each ACU 190 can be configured to control one account when the field devices are connected to NLC 530. For example, each alarm point on AZC 180 can be individually categorized in one of a plurality of categories that also determine the priority of the alarm point. One of these default groups is used in configuring the alarm points managed by the arming control system, thereby eliminating the need to have to mask individual alarm points when disarming areas. Default grouping reduces unnecessary activity and reduces configuration requirements during initial system set-up. A plurality of ACU 190 units can be interfaced to a single NLC 530.

ACU 190 uses an unmarked keypad (not shown) in combination with a display such as a four-line, 80-character Liquid Crystal Display (LCD) for security code entry and data selection. Unlabeled “soft” keys are located proximately to the LCD. In some modes of operation a plurality of the keys above and below represent the numeric keys (0-9). These keys may be labeled in a plurality of different methods; horizontal (eg: 1,2,3,4,5 on top, and 6,7,8,9,0 on bottom), vertical (1,3,5,7,9 on top and 2,4,6,8,0 on bottom) or, for higher security, Rotational and Rotational-PLUS.

The Rotational method presents a new arrangement of number assignments to the keys for each use. The Rotation-PLUS presents a new arrangement of number assignments to the keys after each keystroke. In either mode the keys are always shown in numerical order, however the starting point is always different and randomly determined.

This dynamic keypad labeling makes available the following ACU 190 functions:
Provides functionally integrated system of access control, alarm monitoring and facility controls.
OPEN or CLOSE account (requires entry of a 5-digit “user” security code)
Display Account Status: OPEN, CLOSED, ENTRY DELAY or EXIT DELAY
Display Status for up to 64 zones in the account on one screen: SAFE, ACTIVE ALARM or FAULT, ACTIVE ALARM and MASKED, SAFE and MASKED
Display ACTIVE ALARMS only (one at a time) with full descriptive text name
Display MASKED ZONES only (one at a time) with full descriptive text name
Display CURRENT TIME or REMAINING OPEN TIME (hh:mm:ss)
ARM, DISARM, MASK, UNMASK individual alarm points, and FORCE CLOSE ACCOUNT with alarm points masked (requires entry of a 5-digit “privileged user” security code).

Turning to FIG. 3F, illustrated is a front view of an exemplary embodiment of an ACU 190. ACU 190 has a built in buzzer. One embodiment includes a Piezoelectric buzzer 602. Located to the side of the Piezoelectric buzzer 602, is an 80-character LCD 604 which separates the 80-characters into four lines of 20 characters. Positioned above and below the 80 character LCD are a total of twelve ‘soft’ keys (612, 614, 616, 618, 620, 622, 624, 626, 628, 630, 632, and 634). Of these twelve keys, keys 612, 624 are typically not used for entering the numeric keys (0-9).

Still referring to FIG. 3F under either the rotational or rotation plus modes, the digits 1, 2, 3, 4, 5, 6, 7, 8, 9, 0 may be assigned to the keys respectively. For example, in the rotational-plus mode, the digit 1 is initially assigned to key 628. After any of the digit keys are depressed, the digit 1 may be rotated to key 630 or key 626. The other digits follow the same rotational direction.

ACU 190 may be mounted to a bracket such as a double or triple gang box or to a 4 gang frame. Mounting can be carried by securing the ACU into place by screws. Gang boxes are widely available commercial products.

The Alarm Zone Controller (AZC)

In continued reference to FIG. 3B, AZC 180 is an alarm monitoring field device for use with proprietary IDC 164. AZC 180 functions as an interface between alarm input devices and communications board 170 and NLC 530. AZC 180 features sixteen alarm inputs 181, four form-C output relays 178 for local annunciation or other purposes, communication means such as one RS-485 communication ports 200, and one RS-232 diagnostics port 183, and one tamper input 184. Application programs (firmware) and zone configurations are downloadable into FLASH memory eliminating the need to physically replace EPROMs for application changes and system upgrades. In addition, the AZC 180 continues to monitor alarms and store events in a high capacity buffer during the loss of any communications to the communications board 170. When communications are restored, the buffered events will be transmitted to the server or workstation.

Each AZC 180 is individually addressed and includes local memory for the storage of configuration parameters and events/transactions. Arming control of the alarm point can be performed with ACU 190 near the alarm point. The arming control unit includes a digital keypad and LCD screen, key switches, or simple keypads as explained above in greater detail. ACU 190 interfaces to the NLC 530 through a communication means such as the RS-485 communication ports 200 and RS-485 channel 195. Each alarm point on AZC 180 can be individually categorized in one or more of a plurality of categories that also determine the priority of the alarm point.

The Dual Door Controller

In further reference to FIG. 3B, dual door controller DDC 175 is shown. DDC 175 functions as an access control field device for third party IDC 164. DDC 175 functions as a door interface for NLC 530 and communications board 170, integrating card readers and associated door hardware into a single package. More specifically, DDC 175 provides an interface for at least two auxiliary inputs 176, complete with separate door monitoring inputs, door lock control relays, warning relays, digital and analog exit request inputs and local processing functions. In a preferred embodiment, each DDC 175 includes 4 supervised inputs 177 (2 door monitor and 2 alarm inputs), 8 non-supervised inputs (2 request-to-exit (REX), 2 tamper, and 4 auxiliary inputs 176, 6 form-C output relays 178 (3 per door: door lock, alarm, and spare), and 2 DC outputs for card reader power (not shown). DDC 175 unit is configurable for two doors with entry readers or for one door with entry and exit readers.

DDC 175 includes a high-speed 8-bit microprocessor, downloadable FLASH memory for application programs (firmware), SDRAM for cardholder database and event storage, flexible input and output configurations, two reader ports, and interfaces to NLC 530 via RS-485 communication ports 200 on a communication means such as RS-485 channel 195 via the DDC's 175 RS-485 port 205. RS-485 channel 195 allows DDC 175 to be located up to 4,000 feet from communications board 170 (as also with AZC 180 and the ORC 185). DDC's 175 memory holds 20,000 access card records and all access control decisions for its two readers are made by DDC 175 using this database. When a card's record is not found in DDC 175 database the card data is passed to NLC 530 for the access control decision. Also DDC 175 may update the records of the 20,000 access cards in its database by downloading new card holder data from NLC 530 through communications board 170.

In the following example, DDC's 175 memory originally contains records for 20,000 access cards. An unrecognized card is received by DDC 175. DDC 175 queries the NLC 530 for data regarding the unrecognized card. If the record is found, then access is granted to the cardholder. During this process, DDC 175 acquired additional cardholder information for its database. However, since the database is full, the DDC 175 removes the oldest cardholder data and replaces it with the new cardholder data.

Additionally, if communications between the NLC 530 and DDC 175 is disrupted DDC 175 continues to make access decisions for its 20,000 cardholders based on valid cards and PINs. Up to 512 events are stored at DDC 175 and passed to the NLC 530 when communications are restored. In an alternate embodiment, DDC 175 is fully functional without the assistance of communications with other controller cards, access card records can be downloaded to DDC 175. DDC 175 will continue to function even if the rest of the system is taken offline. Furthermore, access card records for access cards that have not been used for a preset number of days are removed from DDC 175 database and replaced with access card records for more active access cards.

Since DDC 175 stores the access card records locally, it provides relatively fast access grants for improved personnel throughput. Up to 32 DDC 175 devices may be connected to each NLC for a total of up to 64 card-readers at a single NLC 530. DDC 175 will interface third party and industry standard card readers including magnetic strip, Wiegand-effect, proximity, bar code, and various types of smart card readers, as well as biometric devices such as fingerprint and facial recognition devices.

In conjunction with DDC 175 descriptions, the following comprises a non-exclusive list of DDC 175 features:
Supports 2 doors with entry readers or 1 door with entry/exit readers
Each reader port has connections for power, data, 2 LEDs and buzzer
Supports industry standard and custom card formats
Stores 512 events
4 supervised inputs: 2 door monitor and 2 alarm inputs
8 non-supervised inputs: 2 request-to-exit (REX), 2 tamper and 4 auxiliary inputs
6 Form-C output relays (3 per door): door lock, alarm and spare
accepts 6.0-16.0 Vdc power source
downloadable FLASH memory eliminates the need to change EPROMs for applications programming and system upgrades

Turning to FIG. 3C, depicted is a schematic diagram of DDC 175. DDC 175 includes inputs and outputs for two card readers 400 and 402 with a number of connections for each. The connections for each card reader include a data 404, 405, clock 406, 407, voltage input 408, 409, and ground connection 410, 411. DDC 175 also outputs for each card reader a signal for a first LED 412, 413, a signal for a second LED 414, 415, and a signal for a buzzer 416, 417.

RS-485 port 205 which connects to communication board 170. DDC 175 also has input and output connections for controlling two doors 418, 420. Each door control includes an input for the door contacts 422, 423, an input for a request to exit (REX) 424, 425, an output to trigger the door lock relay 426, 427, and an output to trigger a door alarm relay 428, 429. DDC 175 includes two tamper switches 430, 431, each corresponding to a door 418, 420. Additional general purpose inputs 432-437 are also provided for on DDC 175 as are spare relay outputs 438, 439. An RS-232 serial port 440 resident on DDC 175 is used for diagnostic purposes and an I²C port 441 is also included in DDC 175 to make connections with the Access Control Terminal (ACT).

In a preferred embodiment, DDC 175 is also hot swappable. This means DDC 175 can be removed from the system while the system is operating and a new controller card may be inserted in its place. The system registers and detects the presence of DDC 175.

In an alternate embodiment of the DDC, the RS-485 port 205 can be replaced with an Ethernet connection, and the DDC may be implemented as an Ethernet controller. Ethernet controllers are also hot swappable and unplugging and inserting a new controller is as simple as assigning an IP address for the controller when it is plugged in. The IP address may be assigned using a program such as Telnet. The controller itself automatically configures the host computer to make use of it.

In the alternate embodiment of DDC 175, there is sufficient memory provided in the SDRAM to store a schedule and a calendar for an entire year. The calendar stores logs of cardholder's entry and egress at a particular controller. The calendar may be purged on a set timed basis or manually purged. Each time the controller purges data, it begins a new calendar which starts on the date the calendar is purged.

Turning to FIG. 3D, a method is shown for granting access to a door in accordance with the functions of the DDC. The method of FIG. 3D includes the step of receiving access card data 450. The access data is received from a card reader connected to the DDC. DDC 175 attempts to locate the access card data in the local memory at step 452. If the access card data is located in the local memory of DDC 175, access is granted at step 454 and the door is unlocked. However, if the access card data is not found in DDC 175 local memory, then the DDC 175 searches for a connection to the communication board 170 and NLC 530 at step 456. If neither the access card data are found nor a connection to the NLC 530 is active, then access is denied to the holder of the access card at step 458. However, if an active connection to the NLC 530 is found, then the access data is searched for in the NLC 530 at step 462. If the access card data is located in NLC 530 database then the information is downloaded to DDC 175 at step 460 and access is granted at step 454. However, if the NLC database does not contain data for the access card, then the NLC requests the card data from the server at step 466. If the NLC cannot communicate with the server, or the server denies the card, then access is denied at step 458. When door access is denied or granted a corresponding event is logged in memory of DDC 175 and communicated to NLC 530 and onto the server at step 464. If there is connection detected between the NLC 530 and the server but there is a connection between NLC 530 and DDC 175, DDC 175 can upload the up to 512 events from its memory to the memory of NLC 530 and purge its own event storage memory. Ideally, when a connection to the server is detected, both DDC 175 and NLC 530 purge their event memory into the memory of the server or corresponding workstation.

The Access Control Terminal

Access control terminal ACT (not shown) is a keypad access control unit and display. The unit operates with DDC 175 to provide additional security at an entry point by requiring a user to enter a valid Personal Identification Number (PIN) after presenting a card at the card reader. DDC 175 grants access only when the card is valid and the keypad entries match the PIN for that individual. The PIN can be four, five, or six digits in length.

The ACT uses an unmarked keypad in combination with a four-line, 80-character LCD for the PIN entry. Twelve unlabeled “soft” keys surround the LCD display. The five keys above and below the LCD are used as number keys. The keys on each side of the LCD are for special functions. Each time a user presents a card at the associated card reader the LCD displays a new arrangement of number assignments to the keys. The keys are always shown in numerical order, however each time the code is entered the keys rotate. The LCD has a narrow viewing angle which keeps all but the user from seeing the information on the display panel. This dynamic keypad labeling makes available the following ACU 190 functions:

Key assignments rotate for each usage

PIN may be set to 4, 5 or 6 digits

Tactile and audible feedback with each key entry

The Output Relay Controller

In further reference to FIG. 3B, ORC 185 is an output control field device for use with communication board 170 and NLC 530. ORC 185 provides the system interface between the communication board 170 and NLC 530 and other devices that require relay control. Relay outputs can be linked to any system event or input. Some typical uses include signaling devices, locks, lighting, and devices that can be controlled by form-C relays. ORC 185 is interfaced to NLC 530 on a communication means such as the RS-485 channel 195 via RS-485 communication ports 200 and provides 16 Form-C contact relay outputs 186 and 1 tamper input 184. All applications are downloadable into the ORC's 185 FLASH memory thus eliminating the need to replace EPROMs for application changes and system upgrades.

Each of the primary field devices DDC 175, AZC 180, and the ORC 185 are designed with relays that may be used to activate alert devices such as horn and sirens, and building control items such as building lighting, HVAC, and the like. Additional ORC 185 boards can be added to the system for expansion.

Digital Media System

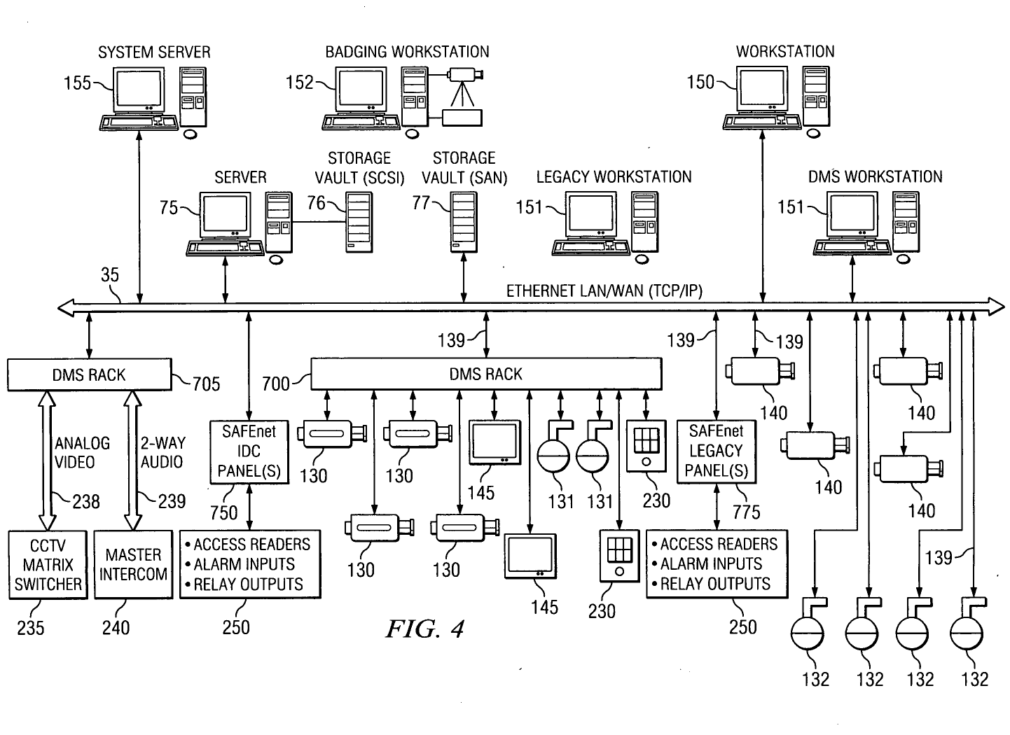

In FIG. 4, a DMS network system is shown. Referring to FIG. 4, the present invention further provides for a DMS that can provide a comprehensive replacement for existing analog CCTV video related security systems. The system further provides analog/network codec card units 165 that enable an end user to retain functionality of analog equipment while adding the benefit of the DMS. The DMS provides a digital video network CCTV replacement that allows current analog systems run by a front end that permits the user to pan, tilt, switch cameras, sequence certain cameras, etc. to continue to execute these same functions but to do them in a digital network format. The DMS converts the output of analog cameras to digital format and in turn compresses that output to enable it to exist within the allocated bandwidth. The DMS system infrastructure provides such compression for any audio, video, or control function plug-in available within the system via IDC 164. Additionally, the present invention provides an Ethernet ready digital cameras 140 having a digital CCD, digital processor, and digital output that are compressed and network ready. Digital camera 140 enables a video stream to be placed directly onto Ethernet 35 in digital format.

Generally, DMS provides hardware and software combinations for digital media management. The DMS system provides digital video/CCTV from analog video 234 through 2-way audio 239 and data record, and management on both smaller scale LAN environments to large scale enterprise networks. Specifically, DMS rationalizes and governs all aspects of the technologies required to provide a digital alternative to analog system DMS exhibits three main features: high-quality audio & video digitization, compression and transmission, unrestrained scalability of numbers of deployed units, and localized & global applications.

Legacy panels 750 and 775 are provided to allow custom connection with order but still useful security systems which are in place and functional.

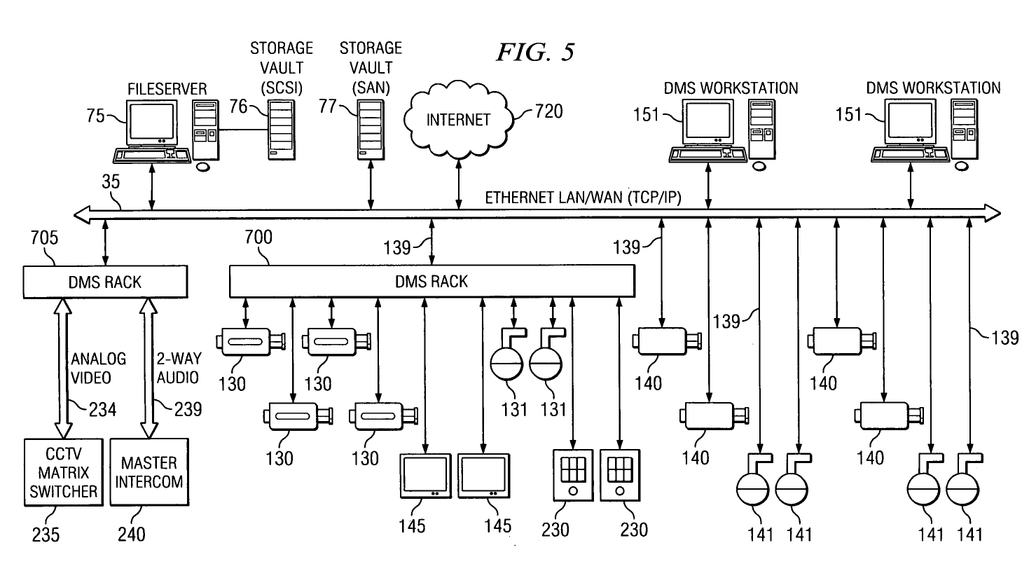

In FIG. 5, a DMS stand alone system separated from the network environment utilizing IDC 164 hardware is shown. Generally, DMS provides for a digital media system infrastructure utilizing the plug-n-play hardware/software concept. DMS allows for the replacement of large analog matrix switchers 235 as found in the prior art (e.g., utilizing coaxial cable in from an analog camera and out to analog monitors, thereby allowing a user to switch any camera to any monitor etc.). DMS provides matrix switching operations completed digitally with IP switching on a Ethernet 35 via DMS codec rack units 700 for analog equipment. Digital IP switching eliminates the need for a large switch and the necessity of lengthy coaxial cables. Coaxial cables are replaced by digital data cabling such as a CAT 5 cable 139 routed from digital cameras to computer workstations such as 150, 151, 152. DMS codec rack units 700 is used to convert analog cameras 130 and analog monitors 145. DMS codec rack units 705 is used to connect analog switches and intercoms to Ethernet 35.

Referring to FIG. 4, the DMS provides access control, alarm management, IDC 164 and digital media, system server 155, badging workstations 152, workstations 150, legacy workstations 151, servers 75, and storage vaults 76 in an integrated system run on a computer network. The network system integrates access control, alarm management, analog/digital CCTV management and 2-way audio 239.

Referring generally to FIG. 5, a DMS stand alone digital audio/video system is shown without integration of specific plug-ins. As a stand alone system, the DMS offers all the features, capacities and capabilities for digital/analog video control functions, and audio applications. In use, cameras and domes 130, 131, 140, 141 can be deployed anywhere access to the Ethernet 35 is available. The need for large coax cabling and matrix switching 235 is eliminated. Additionally, with use of the standalone DMS system, integration of access control, alarm, and/or video functions or a combination of all of the above can be achieved.

The current invention provides a mechanism so that upon the occurrence of certain elements, video signals can be selectively routed and recorded and alarms and alerts can be triggered. For example, a record, sent to the server can also, or a hard drive, be put on a floppy drive to go to the police, etc. Additionally, transmission to the internet 720 can be provided.

Use of the DMS software of the current invention, the programming of a camera is not unlike the programming of a door or an alarm event in the alarm management system. For example, according to one embodiment of the present invention every digital camera 140 in the system captures every frame of information and time stamps any alarms occurring to a particular frame. Each frame is subsequently recorded. A full video record is created that enables real time viewing of video information that occurred prior to a specific alarm. To accomplish this, DMS uses an MPEG 4 compression algorithm. MPEG 4 provides quality full resolution video on a Ethernet 35 but the low bandwidth requirements. MPEG 4 resolution is surpasses the capabilities of a standard analog camera. In addition, by time stamping or tying alarms or events/triggers to a specific time in a stream of video, the user can go backward or forwards within a specific stream of video to view the full scene.

Digital cameras 140 and domes 141 of the present invention are placed on the network having no fixed IP address. The DMS system software searches the IP address and assigns each unassigned camera in the field an IP address based on the camera's media access control (MAC) address. The DMS system software uses Dynamic Host Configuration Protocol (DHCP). The operating principle of DHCP assumes that a device (e.g., a camera) knows nothing about its own network settings and sends out a broadcast packet essentially requesting instructions. That is, for example, as soon as a device is plugged in the device wakes up with a MAC address and begins requesting a DHCP address. The DHCP server listens for these requests and responds with a packet containing the settings that define the parameters for device connection. The DHCP server is configured with a table of Ethernet addresses, ranges of IP addresses, and maps that define a correlation between devices and IP addresses. In the present embodiment, a DHCP server is configured on the Ethernet 35. The DHCP server assigns IP addresses randomly to devices (e.g., digital camera 140, domes 141, etc.) whose MAC address are not predefined. However, if a device does have a predefined, recognized MAC address the DHCP server assigns that IP address to the device. The DMS system of the present invention can convert IP addresses to logical addresses (e.g., the “camera at the front door”). Once a logical address is assigned, the DMS software enables the search and discovery of the location of equipment by a logical address, or the IP addresses, and/or the specific configuration of the installed devices. In this embodiment, devices may be installed on the network without the knowledge of IP addresses by the user. The present invention additionally provides for a DMS specific protocol in connection with or in place of the DHCP protocol that will facilitate IP addressing.

In further reference to FIG. 5, DMS, by virtue of its ability to interface with both digital technologies and analog technologies, permits the creation of “Hybrid” CCTV systems. DMS preserves legacy CCTV systems while allowing use of newer digital equipment. DMS provides for digital video inputs, analog inputs (cameras, switchers, etc.) and analog outputs (video monitors). Currently the DMS operates under Windows 2000 client/server architecture and provides up to 100 video streams per server each at up to 30 fps (up to 3,000 fps/server). DMS provides unique MPEG-4 network video encoders and decoders codec card units 165 with the expansion to meet virtually any application that is available with DMRS storage 76, workstations 151, DMS server 75 and codec card units 165.

The present invention provides for a much needed IP switching capability, extensive motion, event and time based recording and flexible search and playback. To accomplish this, DMS provides hardware consisting of various component features as will be explained below.

With reference to FIG. 5 there are two types of computers in the DMS system: the DMS fileserver and the DMS workstation 151.

DMS Digital Video Fileserver/Recorder

The fileserver 75 is a dedicated, Pentium Class computer running Windows 2000 (or later) and is optimized for the input channel and storage capacity requirements of the specific application being supported. Fileserver 75 is capable of recording up to 100 video streams at up to 30 fps each and can be installed in multiple server units depending on the size and need of the user's application.

DMS Workstation

The workstation 151 provides the primary interface to the DMS system. Workstation 151 can either be a dedicated Windows 2000 based PC or can be applied as an application running on existing Windows 2000 based PCs. To further expand the integration and interoperability of the DMS system, workstation 150 integrates the DMS functionality along with the DMS client workstation 151.

DMS Storage Vault(s)

Storage vault 76 provides the primary media storage and retrieval functions of the system. Storage vault 76 is managed by fileserver 75 as described above and is available as direct connect to the fileserver (SCSI) or networked (SAN) 77. A storage area network (SAN) is a high-speed special-purpose network (or subnetwork) that interconnects different kinds of data storage devices with associated data servers on behalf of a larger network of users. Typically, a storage area network SAN is part of the overall network of computing resources for an enterprise. A storage area network is usually clustered in close proximity to other computing resources but may also extend to remote locations for backup and archival storage, using wide area network carrier technologies. Additionally, SAN's support disk mirroring, backup/restore, archival and retrieval of archived data, data migration from one storage device to another, and the sharing of data among different servers within a network. SAN's comprise the capability to incorporate subnetworks with network-attached storage (NAS) systems. In addition, the storage vault(s) are configurable up to many terabytes and can be installed in multiple units as may be required by the application.

DMS CODECs and Rack Unit(s)

In further reference to FIG. 5, the DMS CODEC (Compressor/Decompressor) rack units 700 and 705 encode and decode analog video 238, intercom stations 230, 240 to and from 239 digital formats for storage, retrieval and transmission. DMS provides a standard EIA 19″ codec card unit including a backplane, power supply, connectors, and slots for a plurality of modules. Typically, at least ten rack mountable DMS codec modules such as the DMS 4 channel I/O codec and the DMS 1 channel I/O codec (neither shown) are provided. The DMS 4-channel codec is configured as an encoder for video/audio inputs (Server) or a decoder for video/audio 238, 239 outputs (Client) and is further available as codec card unit 165 or with a specific dedicated enclosure (a unit). Similarly, the DMS 1-channel codec is configured as an encoder for video/audio input (Server) or a decoder for video/audio output (Client) and is also available as codec card units 165.

In addition, the present invention further provides for the installation of codec cards into existing equipment (e.g., analog monitors 145, etc.) to allow a user to utilize plug-n-play type network appliances that are a CCTV system where no coax cabling is involved. Additionally, the codec cards disclosed herein uniquely places object processing intelligence directly onto the codec card itself so as to allow certain decisions to be made at the camera level itself. In this specific application each camera containing the codec is enabled to make object processing decisions that can, for example, set an alert or alarm and can force streaming/recording of video or can stream video of an event that is occurring directly to a cell phone, personal digital assistant (PDA), or other similar devices. For example, a flag could be preset in the codec to send a picture of a lobby if a person has been loitering in the lobby for “X” minutes or if motion is detected such as a door opening or someone turning on a light.

DMS Digital Cameras

FIG. 5 also depicts DMS digital cameras 140 comprising the built-in CODEC modules and are designed to be functionally and communicably connected directly to an Ethernet 35. The DMS software utilized by the present invention consists of a plurality of features as will now be explained.

DMS Software Overview

The DMS software is provided for both the DMS fileserver 75 and the DMS workstations 151. DMS fileserver 75 software provides the central management for network traffic, recording, and distribution. DMS storage is provided locally in storage vaults 76 (SCSI) or storage vaults 77 (SAN/RAID). DMS workstation 151 software provides for local viewing of live and recorded video, audio, control of PTZ cameras, and to send/receive data streams and more. Administration functions permit those authorized to have full access to remotely administer the DMS System. This is also available as an integrated module.

DMS—Network & Storage Considerations

Network based digital video transmission and recording can be demanding of network bandwidth and can require large storage arrays. There are many ways of reducing this demand in the prior art. However, most of these ways have a dramatic impact on the system; for example: choosing low frame rate/bandwidth cameras require analysis of camera location. Other prior art methods include overuse of medium resolution cameras (using high-resolutions only where necessary), lowering the frame-rate on time recordings (to increase on motion/event based recordings) and reducing live video viewing stations to a minimum. However, DMS negates the need to reduce the security aspects of the system without having to pay high-costs by utilizing a high efficiency codec platform that generates high quality video at network and disk utilization levels that other systems can only match at low quality video settings.

By moving to DMS network devices, instead of prior art methods of pure analog systems, the present DMS system can control and monitor any device at any time. Within the DMS architecture, system controllers have access to the devices on a central network (local or remote) to which they have authorized access. All access rights and the granting of permissions are controlled through the central network's site manager which in turn is managed locally or remotely using secured software.

Additionally, the DMS system provides for audit traces of specific device or system commands, configuration changes and user-logins through networked command and data loggers. Coupled with rules and filters the data loggers can also be used to detect, in real-time, any behavior that may be considered suspicious, helping to detect electronic attacks that may occur before physical ones.

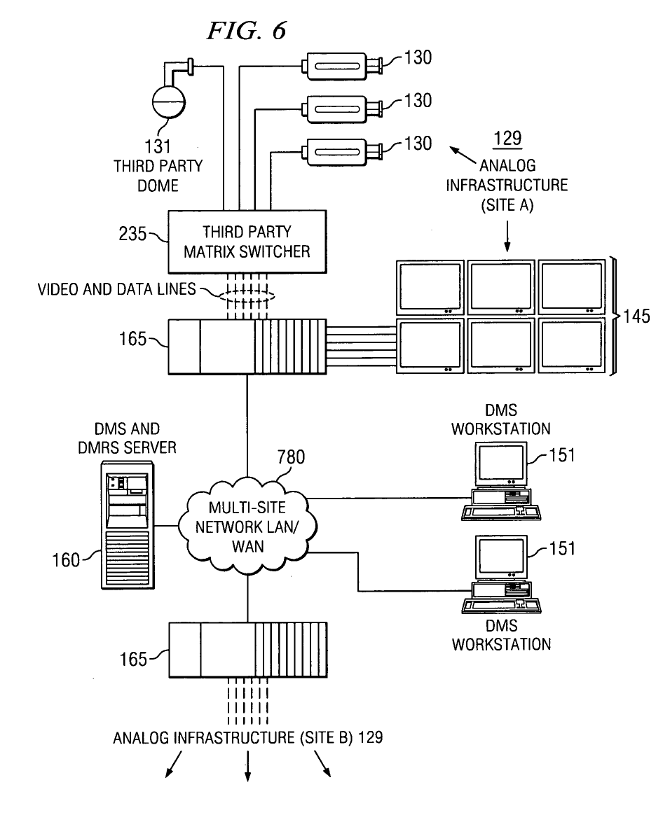

Now referring to FIG. 6, the DMS system including the DMRS 160 has full functional ability to integrate DMS with existing analog infrastructures 129 (Site A & Site B in FIG. 6) and third party devices such as analog PTZ domes 131, or matrix switchers 235 without requiring the replacement of and loss of initial investments in existing analog equipment by utilizing codec card units 165 to connect to multi-site network LAN/WAN 780. All analog devices can be controlled from the DMS system software and workstations 151 and will further allow similar products from existing systems to successfully convert to the digital system without removing or replacing existing analog cameras 130, analog monitors 145, and recorders. Plug-ins suitable to the product being interfaced are simply added as required to the DMS system saving the user time, money and effort in maintaining two sets of equipment that perform nearly parallel functions.

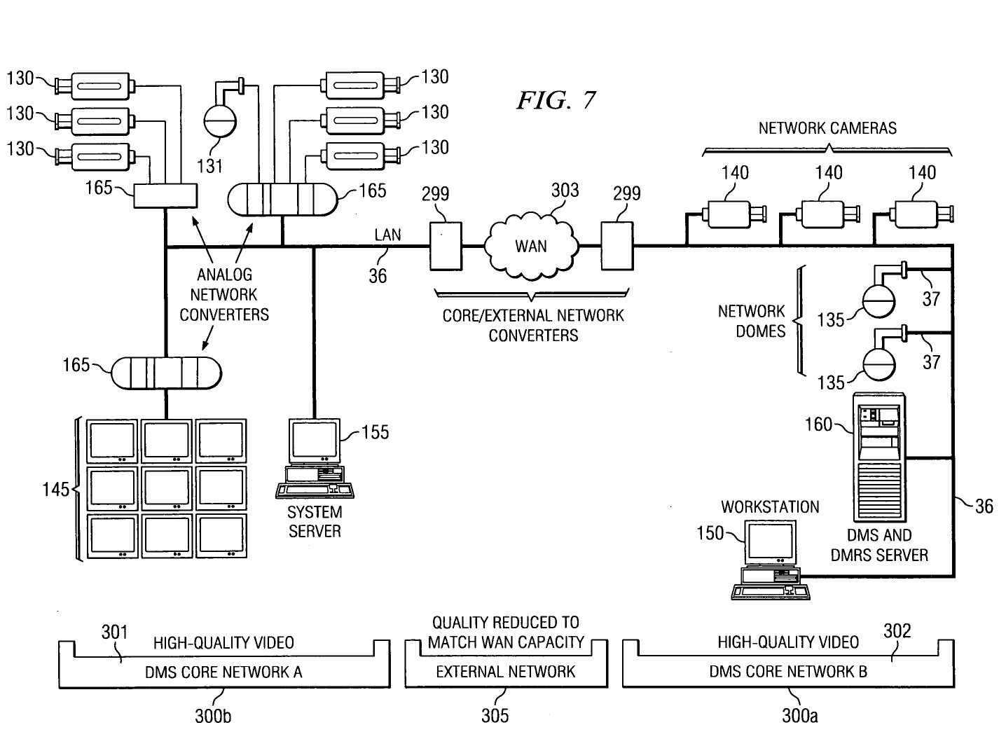

Now referring to FIG. 7, DMS defines two types of networks, core networks 300a and 300b and external network 305. Core networks include either 100Base-T or 1000Base-T Ethernet devices. For example, core networks 300 have the capability to carry hundreds of high-quality, high resolution and high-frame-rate video channels. DMS system devices operating in the core network 300 always share and maintain high-quality streams without dramatically affecting the real-time performance of the video and audio encoding processor.

FIG. 7 further shows a DMS core network “A” 301 and a DMS core network “B” 302. Core network “B” 302 provides for DMS digital devices that are connected via CAT 5 connections 37. Ethernet connections do not require an interface box (codec rack unit). Core network 301 consists of a local area network LAN 36 where data capacity and error rate are easily determinable. These deterministic attributes support high quality video transmission at high data rates and high data rates facilitate a high number of video channels. Core network “A” 301 in FIG. 7 shows the use of such codec card units 165 that enables connection to existing analog devices (e.g., analog cameras 130, analog PTZ domes 131, etc.) and conversion to a digital format for network 36 connection and transmission.

In further reference to FIG. 7, an external network 305 is depicted. An external network 305 provides for any other network besides the core networks. One example is a wide area network (WAN) 303 interconnecting two facilities. Unlike a core networks 300, the capabilities of external networks 305 are typically left with the control of an integrator for the customer. This requires the DMS system to tailor media transmission to match the capability of the external network 305. More specifically, video and/or audio quality may need to be reduced to match the WAN 303 capacity. Devices in the external network 305 connect to core networks 300 via the external network using core/external network converters 302 and must modify their encoding to match the external network's properties in real time. For example, an external network 305 would be any kind of network regardless of data capacity that requires some form of media conversion. Unlike core networks 300, however, the external networks 305 and its properties and the technology being used for conversion and its properties are very unpredictable.

Core/external network connections 302 include transcoder devices that assist in remote connectivity to a system. The transcoder device of the present invention assists the user in streaming a plurality of information when a limitation to the streaming bandwidth exists or is presented regardless of the cause of the restraint. The transcoder device permits continuous high resolution (30 fps) recording while reducing the streaming frame rate to accommodate a lower bandwidth that may be needed by the end user. The transcoder device has specifically defined application when a user desires to be alerted of an event (alarm condition etc.), for example, on a personal digital assistant or cell phone when there is limited bandwidth available. The transcoder device allows for necessary reduced quality (accomplished via reduced resolution, quality, and/or frame rate) video to be streamed although the recorder 160 continues to record high resolution, full frame rate, and for recorded files to be played back to remote devices at a quality suitable to the remote device's connection.

Although previously generally referenced in FIGS. 4 through 7, the present invention provides for a digital media recording system (DMRS) 160 storage medium that is functionally operable as a separate server 160. In this embodiment the DMRS 160 software of the system is multi-configurable and can record various types of media having at least 100 streams of information while playing back the media on 10 or more monitors in full resolution digital video. In addition, DMRS 160 system allows for the playback of a file that is currently being recorded and operationally and functionally prioritizes the recording of the media above the playback.

The DMRS 160 system is capable of storing media other than just video. The DMRS 160 system can record audio/video from a camera and can also record audio transmitted back to a camera. In addition, the system records other auxiliary data which in itself is bi-directional in nature. The recorder of the present invention is capable of recording in 5 channels of data with the current file format. For example, there is 1 video channel from the camera, 2 channels for audio to/from the camera, and then 2 channels for Input/Output data to and from the camera. This 5 channel capability enables audio/video and all aspects of other communications associated with data for each specific camera on the network to be recorded. Such recorded information comprises control data including opening doors, closing doors, panning, tilting, and the changing of multiplexer channels this all being done in conjunction with audio and video media information recording.

The DMRS 160 system is designed to utilize all the disk space a system has to ensure that the user has recorded all frames and pixels until the disk full, making use of their investment to the maximum. It is not until the disk is full that the system and/or user decide what must be deleted and what must be kept. It is at this point that the use of recorded trigger information becomes useful as will now be explained. In the DMRS 160 system, during the recording of events or external triggers, the recording frame rate does not change as is common in prior systems. However, in the DRMS 160 system “alarms” are tied to the video stream to indicate to the user that certain specified portions of the video contain video relating to events or triggers that may be useful. As described above, when the disk becomes full and a determination has been made to delete information, only those portions of the video having no alarms associated with specific segments of video can be selectively deleted by the user. This option allows the system and/or the user to have time to go to any of these video segments and flag them as “do not delete” segments. In addition, the DMRS software enables a user to indicate when certain events or alarms have happened in the video (e.g., motion detected, activation of a pressure mat) for later review and evaluation.

The DMRS 160 system time stamps at least the networked digital camera 140 and controllers. Each camera module, microphone etc. contains an internal clock which enables synchronization of video and audio but is ultimately synched to the controller. If a situation arose wherein the video from one camera, the audio from another source, and control data from another source all are being stored into the same file, millisecond clocks are used to track the clock drift of various platforms and are assigned a millisecond time stamp by the recorder itself. Ultimately, all network packets and control data to be recorded are picked up by the recorder 160. A worst case scenario would cause the alignment of all recorded information be according to the controller block itself.

Although the invention has been described with reference to one or more preferred embodiments, this description is not to be construed in a limiting sense. There are possible modifications of the disclosed embodiments, as well as alternative embodiments of this invention which will be apparent to persons of ordinary skill in the art. Therefore, the invention shall be viewed as limited only by reference to the following claims.

As will be recognized by those skilled in the art, the innovative concepts described in the present application can be modified and varied over a tremendous range of applications, and accordingly the scope of patented subject matter is not limited by any of the specific exemplary teachings given.

1. A method of controlling access to a restricted area using an integrated electronic system, comprising the steps of:
reading identification information input from one or more data inputs through one or more data input modules into the integrated electronic system;
verifying that the identification information is authentic;
comparing the identification information with a known database of previously recorded identification information of authorized users; and,
permitting or denying access to a restricted area.

2. The method of claim 1 further comprising the steps of:
recording audio and/or video input of the individual seeking access to the restricted area;
compressing the recording; and
storing the recording on electronic media.

3. The method of claim 1 wherein one or more data input modules are comprised of a biometrics reader, a security access password, a security card reader, or combinations thereof.

4. The method of claim 1 wherein the database is connected to the integrated electronic system via an Ethernet connection.

5. The method of claim 1 wherein the data input modules are comprised of an image recognition system, a digital media system, or combinations thereof.

6. The method of claim 5 wherein the digital media system includes a video recording module.

7. The system of claim A5 wherein the digital media system records only on a event basis.

8. The method of claim 6 wherein the digital media system includes an audio recording module.

9. The method of claim 8 wherein the digital media system records only on an event basis.

10. A system for providing security and access control to a restricted area comprising:
a host computer with an operating system;
a first controller card for controlling at least one security door;
at least one authentication module for reading authorization information; and
a mechanism for communication between the controller card and the host computer.

11. The system of claim 10 wherein the mechanism for communication between the controller card and the host computer is thru an Ethernet LAN or WAN.

12. The system of claim 10 wherein the mechanism of communication between the controller card and the host computer is a second controller card wherein the second controller card stores and relays access control data.

13. The system of claim 10 wherein the second controller card communicates with the first controller card via a communications board.

14. The system of claim 10 wherein at least one authentication module comprises a biometrics reader, a security access password, a security card reader, or combinations thereof.

15. The system of claim 10 wherein the host computer uses a 32-bit microprocessor.

16. The system of claim 10 wherein the host processor uses flash memory to store authentication information.

17. The system of claim 10 further comprising a diagnostic port.

18. The system of claim 17 wherein the diagnostic port is a RS-232 port.

19. The system of claim 10 wherein the controller card further comprises an output module to display the current status of any modules described by claim 10.

20. The system of claim 10 further comprising a tamper prevention device.

21. The system of claim 10 wherein the controller card further comprises multiple outputs.

22. The system of claim 21 wherein the multiple outputs include a request-to-exit output.

23. The system of claim 10 further comprising a device to record video of the area surrounding the security door.

24. A controller card for regulating entry to at least one security door comprising:
a processor for making one or more access control decisions;
flash memory for storing application programs;
memory for storing a cardholder database;
a first port for communicating with a network controller card;
one or more ports for receiving data from one or more card readers; and
one or more ports for controlling one or more security doors.

25. The controller card of claim 24 wherein the memory logs events.

26. The controller card of claim 24 wherein the first port is an Ethernet port.

27. The controller card of claim 24, wherein the network controller card connects to audio and/or video recording hardware.

28. A method for controlling access for a security door from a door controller card comprising:
receiving access card data from a card reader;
determining whether a secure network connection exists between the door controller card and a network controller card; and
comparing the access card data to a local database stored in the door.

29. The method of claim 28, wherein a grant of access to the security door requires locating a valid record of the access card data in the local database.

30. The method of claim 28 wherein determining whether a network connection exists comprises determining whether electrical power is available to the network controller card.

31. The method of claim 28 wherein the local database is stored on a removable disk drive device.

32. The method of 31 wherein the removable disk drive device is stored in an enclosure with at least one tamper prevention switch.

33. A system for detecting unauthorized access to a security device, comprising:
at least one tamper prevention switch electrically connected to a host computer;
operating software for the host computer;
a first controller card for controlling at least one security door;
at least one authentication module for reading authorization information; and
a mechanism for communicating between the controller card and the host computer.

34. The system of claim 33 further comprising software for notifying a system administrator of an unauthorized access to a security device.

35. The system of claim 33 wherein at least one authentication module includes a video recording module.

36. The system of claim 35 wherein the video recording module records only on a event basis.

37. The system of claim 33 wherein at least one authentication module includes an audio recording module.

38. The system of claim 36 wherein the audio recording module records only on an event basis.

39. A method of detecting tampering to a security device, comprising the steps of:
securing an enclosure with a plurality of enclosing panels surrounding at least one electronic module;
detecting unauthorized tampering with the enclosure;
logging unauthorized tampering; and
denying access to restricted area.

40. The method of claim 39 further comprising the step of recording audio after the detection of unauthorized tampering to the security device.

41. The method of claim 39 further comprising the step of recording video after the detection of authorized tampering to the security device.

42. The method of claim 39 further comprising the step of notifying a system administrator through a network connection to the unauthorized access.

43. The method of claim 39 further comprising the step of denying access to the restricted area.

44. The method of claim 39 wherein the denial of access comprises the step of locking a security door.

45. A system for regulating access to a restricted area, comprising:
a security module for recognizing a request for access to a restricted area;
a network connection to connect the security module to a LAN or WAN;
a network controller connected to the security modules via an Ethernet connection to a LAN or WAN;
a host computer with operating software connected to the network controller and;
at least one authentication module.

46. The system of claim 45 further comprising an arming control unit.

47. The system of claim 46 wherein the arming control unit contains a keypad.

48. The system of claim 47 wherein the assignment of the values of the keys on the keypad changes in a predetermined pattern.

49. An access control system for regulating access comprising:
a host computer with operating software;
a least one authentication module for determining authorized users; and
a keypad wherein the numbers assigned to keys on the keypad are capable of being changed.

50. The access control unit of claim 49 wherein the keypad is unlabeled.

51. The access control unit of claim 49 further comprising a display screen displaying the numbers assigned to keys of the unlabeled keypad.

52. The access control unit of claim 49 wherein the numbers assigned to keys of the keypad are displayed on a changeable screen.

53. The access control unit of claim 49 wherein the numbers assigned to keys of the keypad are changed in a predetermined pattern.

54. The access control unit of claim 49 wherein the numbers assigned to keys of the keypad are changed in a random pattern.
